(19) United States
(12) Patent Application Publication
(10) Pub. No.: US 2025/0093381 A1
(43) Pub. Date: Mar. 20, 2025

(54) AUTOMATIC CALIBRATION METHOD, DEVICE, AND SYSTEM FOR ANGLE SENSOR

(71) Applicant: JIANGSU XCMG STATE KEY LABORATORY TECHNOLOGY CO., LTD., Xuzhou (CN)

(72) Inventors: Huijuan LIU, Xuzhou (CN); Meina WANG, Xuzhou (CN); Adin BASIC, Xuzhou (CN); Huan ZHAO, Xuzhou (CN)

(73) Assignee: JIANGSU XCMG STATE KEY LABORATORY TECHNOLOGY CO., LTD., Xuzhou (CN)

(21) Appl. No.: 18/782,110

(22) Filed: Jul. 24, 2024

(30) Foreign Application Priority Data
Sep. 20, 2023 (CN) 202311221261.1

(51) Int. Cl. G01P 21/00

(52) U.S. Cl. CPC G01P 21/00

(57) ABSTRACT

A method, including: obtaining first acceleration data output by an angle sensor at each first test angle and corresponding second acceleration data which is nominal data in case where the angle sensor rotates about a first axis; obtaining third acceleration data output by the angle sensor at each second test angle and corresponding fourth acceleration data which is nominal data in case where the angle sensor rotates about a second axis in a situation that a turntable mechanical platform rotates 90 degrees about a third axis; constructing a calibration data model between output acceleration data and calibrated acceleration data, based on the first, second, third, and fourth acceleration data; determining calibrated acceleration data corresponding to acceleration data output at any angle based on the calibration data model; and obtaining a calibrated angle of the angle sensor at any angle based on the calibrated acceleration data of that angle.

### CROSS-REFERENCE TO RELATED APPLICATIONS

The present disclosure is based on and claims priority of CN Patent Application No. 202311221261.1 filed on Sep. 20, 2023, the disclosure of which is hereby incorporated by reference in its entirety.

### TECHNICAL FIELD

The present disclosure relates to the field of engineering machinery sensors, and in particular to an automatic calibration method, device, and system for an angle sensor.

### BACKGROUND

At present, angle sensors used in engineering machinery are mainly divided into static angle sensors and dynamic angle sensors. Inertial measurement units (IMUs), which comprise gyroscopes and accelerometers, are the core components of dynamic angle sensor systems. The hardware systems of dynamic angle sensors are formed by sensing units composed of IMUs and microcontrollers.

In related technologies, sensor calibration is achieved by applying a single acceleration signal corresponding to a voltage signal per individual axis and direction.

### SUMMARY

According to an aspect of the present disclosure, an automatic calibration method for an angle sensor, wherein the angle sensor is placed on a turntable mechanical platform, the turntable mechanical platform being rotatable about a first axis, a second axis, and a third axis, the first axis and the second axis being perpendicular to each other and forming a horizontal plane, the third axis being perpendicular to the horizontal plane, and the automatic calibration method for the angle sensor comprising: obtaining first acceleration data output by the angle sensor at each first test angle and corresponding second acceleration data which is nominal data in a case where the angle sensor rotates about the first axis, wherein the turntable mechanical platform in a first initial state of rotating about the first axis is parallel to the horizontal plane; obtaining third acceleration data output by the angle sensor at each second test angle and corresponding fourth acceleration data which is nominal data in a case where the angle sensor rotates about the second axis in a situation that the turntable mechanical platform rotates 90 degrees about the third axis, wherein the turntable mechanical platform in a second initial state of rotating about the second axis is parallel to the horizontal plane; constructing a calibration data model between output acceleration data and calibrated acceleration data, based on the first acceleration data, the second acceleration data, the third acceleration data, and the fourth acceleration data; determining calibrated acceleration data corresponding to acceleration data output at any angle based on the calibration data model; and obtaining a calibrated angle of the angle sensor at any angle based on the calibrated acceleration data of that angle.

In some embodiments, constructing the calibration data model between the output acceleration data and the calibrated acceleration data comprises: obtaining a fitting function by performing a fitting process on the first acceleration data, the second acceleration data, the third acceleration data and the fourth acceleration data; and obtaining the calibration data model based on coefficient parameters of the fitting function.

In some embodiments, constructing the calibration data model between the output acceleration data and the calibrated acceleration data further comprises: obtaining first fitted acceleration data corresponding to each first test angle and second fitted acceleration data corresponding to each second test angle, based on the fitting function; obtaining an error parameter of the fitting function based on an acceleration difference between the second acceleration data and the first fitted acceleration data corresponding to each first test angle, as well as an acceleration difference between the fourth acceleration data and the second fitted acceleration data corresponding to each second test angle; and obtaining the calibration data model based on the coefficient parameters and the error parameter of the fitting function.

In some embodiments, the error parameter value determined for the calibrated angular velocity data corresponding to the acceleration data that is output at any angle based on the calibration data model is: an acceleration difference corresponding to a test angle that is closest to that angle.

In some embodiments, the error parameter value determined for the calibrated angular velocity data corresponding to the acceleration data that is output at any angle based on the calibration data model is: an acceleration difference corresponding to a test angle that is less than and closest to that angle.

In some embodiments, obtaining the error parameter of the fitting function comprises: calculating an average value of the acceleration difference corresponding to each first test angle and the acceleration difference corresponding to each second test angle to obtain the error parameter of the fitting function.

In some embodiments, performing a fitting process comprises: performing linear fitting based on a least square method.

In some embodiments, obtaining first acceleration data output by the angle sensor at each first test angle and corresponding second acceleration data which is nominal data in a case where the angle sensor rotates about the first axis comprises: receiving a calibration instruction sent from a controller of the turntable mechanical platform; sending a calibration permission response to the controller to control the turntable mechanical platform to rotate from the first initial state to each first test angle; and receiving a value corresponding to each first test angle of the turntable mechanical platform that is sent from the controller, and recording the second acceleration data corresponding to each first test angle, and the first acceleration data output by the angle sensor.

In some embodiments, obtaining third acceleration data output by the angle sensor at each second test angle and corresponding fourth acceleration data which is nominal data in a case where the angle sensor rotates about the first axis comprises:
receiving a calibration instruction sent from a controller of the turntable mechanical platform; sending a calibration permission response to the controller to control the turntable mechanical platform to rotate from the second initial state to each second test angle; and receiving a value corresponding to each second test angle of the turntable mechanical platform that is sent from the controller, and recording the fourth acceleration data corresponding to each second test angle, and the third acceleration data output by the angle sensor.

In some embodiments, receiving a calibration instruction sent from a controller of the turntable mechanical platform comprises: receiving the calibration instruction sent from the controller of the turntable mechanical platform via a control local area network (CAN) bus.

In some embodiments, obtaining first acceleration data output by the angle sensor at each first test angle comprises: obtaining a first offset based on acceleration data measured by the angle sensor in a case where the turntable mechanical platform is in the first initial state; and calibrating acceleration data measured by the angle sensor at each first test angle based on the first offset to obtain the first acceleration data.

In some embodiments, obtaining third acceleration data output by the angle sensor at each second test angle comprises: obtaining a second offset based on acceleration data measured by the angle sensor in a case where the turntable mechanical platform is in the second initial state; and calibrating acceleration data measured by the angle sensor at each second test angle based on the second offset to obtain the third acceleration data.

In some embodiments, verifying the calibrated angle corresponding to any angle, based on a test angle rotated by the turntable mechanical platform.

According to another aspect of the present disclosure, an automatic angle sensor calibration device is further provided, wherein the angle sensor is placed on a turntable mechanical platform that can rotate about a first axis, a second axis, and a third axis, the first axis and second axis being perpendicular to each other and forming a horizontal plane, the third axis being perpendicular to the horizontal plane, the automatic angle sensor calibration device comprising: a data acquisition module configured to obtain first acceleration data output by the angle sensor at each first test angle and corresponding second acceleration data which is nominal data in a case where the angle sensor rotates about the first axis, wherein the turntable mechanical platform in a first initial state of rotating about the first axis is parallel to the horizontal plane, and obtain third acceleration data output by the angle sensor at each second test angle and corresponding fourth acceleration data which is nominal data in a case where the angle sensor rotates about the second axis in a situation that the turntable mechanical platform rotates 90 degrees about the third axis, wherein the turntable mechanical platform in a second initial state of rotating about the second axis is parallel to the horizontal plane; a model establishment module configured to construct a calibration data model between output acceleration data and calibrated acceleration data, based on the first acceleration data, the second acceleration data, the third acceleration data, and the fourth acceleration data; and a calibration output module configured to determine calibrated acceleration data corresponding to acceleration data output at any angle based on the calibration data model, and obtain t a calibrated angle of the angle sensor at any angle based on the calibrated acceleration data of that angle.

According to a further aspect of the present disclosure, an automatic angle sensor calibration device is further provided, comprising: a memory; and a processor coupled to the memory, the processor configured to perform the automatic calibration method for angle sensor described above based on instructions stored in the memory.

According to a further aspect of the present disclosure, an automatic angle sensor calibration system is further provided, comprising: at least one angle sensor, wherein each angle sensor of the at least one angle sensor is provided with an automatic angle sensor calibration device; a turntable mechanical platform for mounting the at least one angle sensor; and a controller of the turntable mechanical platform configured to control the turntable mechanical platform to rotate about the first axis, the second axis, and the third axis, and send rotation angles of the turntable mechanical platform about the first axis and the second axis to the automatic angle sensor calibration device.

In some embodiments, the controller is further configured to send a calibration instruction to the automatic angle sensor calibration device and, upon receiving a calibration response, control the turntable mechanical platform to rotate about the first axis or the second axis.

In some embodiments, the automatic angle sensor calibration device is implemented based on calibration software inside a corresponding angle sensor.

In some embodiments, the controller communicates with the turntable mechanical platform through a serial port.

According to a further aspect of the present invention, there is further provided a computer readable storage medium having stored thereon computer program instructions that, when executed by a processor, implement the automatic calibration method for angle sensor described above.

Other features and advantages of the present invention will become apparent from the following detailed description of exemplary embodiments of the present disclosure with reference to the accompanying drawings.

### BRIEF DESCRIPTION OF THE DRAWINGS

The accompanying drawings, which are incorporated in and constitute a portion of this specification, illustrate embodiments of the present disclosure and, together with the description, serve to explain the principles of the present disclosure.

The present disclosure will be more clearly understood from the following detailed description with reference to the accompanying drawings, in which:

FIG. 1 is a flowchart of an automatic calibration method for an angle sensor according to some embodiments of the present disclosure;

FIG. 2 is a flowchart of an automatic calibration method for an angle sensor according to other embodiments of the present disclosure;

FIG. 3 is a flowchart of an automatic calibration method for an angle sensor according to further embodiments of the present disclosure;

FIG. 4 is a flowchart of an automatic calibration method for an angle sensor according to further embodiments of the present disclosure;

FIG. 5 is a flowchart of an automatic calibration method for an angle sensor according to further embodiments of the present disclosure;

FIG. 6 is a schematic structure diagram of an automatic calibration device for an angle sensor according to some embodiments of the present disclosure;

FIG. 7 is a schematic structure diagram of an automatic calibration device for an angle sensor according to other embodiments of the present disclosure;

FIG. 8 is a schematic structure diagram of an automatic calibration system for an angle sensor according to some embodiments of the present disclosure.

### DETAILED DESCRIPTION

Various exemplary embodiments of the present disclosure will now be described in detail with reference to the accompanying drawings. Notice that, unless otherwise specified, the relative arrangement, numerical expressions and values of the components and steps set forth in these examples do not limit the scope of the invention.

At the same time, it should be understood that, for ease of description, the dimensions of the various parts shown in the drawings are not drawn to actual proportions.

The following description of at least one exemplary embodiment is in fact merely illustrative and is in no way intended as a limitation to the invention, its application or use.

Techniques, methods, and device known to those of ordinary skill in the relevant art may not be discussed in detail, but where appropriate, these techniques, methods, and devices should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an item is defined in a drawing, there is no need for further discussion in the accompanying drawings.

For a clear understanding of the object of the present disclosure, its technical solution and advantages, the present disclosure will be further described in detail below in conjunction with the accompanying drawings and embodiments.

In the three-axis accelerometer measurement results of a dynamic angle sensor, the relevant technology cannot distinguish the effect of other directional accelerations on an angle measurement, which will undermine the calibration accuracy of the dynamic sensor to some extent.

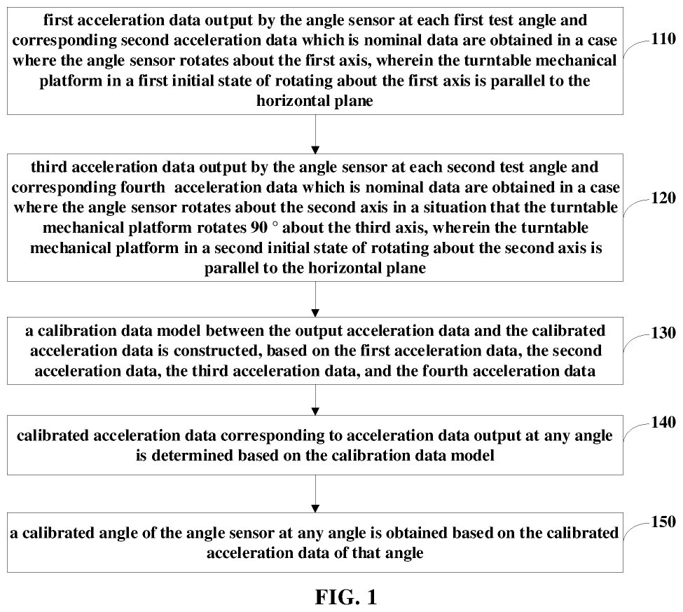

FIG. 1 is a flowchart of an automatic calibration method for an angle sensor according to some embodiments of the present disclosure. This embodiment is executed by an automatic calibration device for the angle sensor implemented based on internal calibration software of a corresponding angle sensor. The automatic calibration device for the angle sensor communicates directly with a controller of a turntable mechanical platform to reduce data transmission.

In some embodiments, the angle sensor is a dynamic angle sensor.

The turntable mechanical platform in this embodiment can rotate about a first axis, a second axis, and a third axis, wherein the first axis and the second axis are perpendicular to each other and form a horizontal plane, and the third axis is perpendicular to the horizontal plane, i.e., the third axis is parallel to the direction of gravity acceleration. The angle sensor is placed on a turntable mechanical platform. For example, the angle sensor to be calibrated is fixed on the turntable mechanical platform.

In step 110, first acceleration data output by the angle sensor at each first test angle and corresponding second acceleration data which is nominal data are obtained in a case where the angle sensor rotates about the first axis, wherein the turntable mechanical platform in a first initial state of rotating about the first axis is parallel to the horizontal plane.

For example, the controller of the turntable mechanical platform controls the turntable mechanical platform to move to a horizontal origin position. That is, the turntable mechanical platform is rotated to be parallel to the horizontal plane in order to calibrate the zero point of the angle sensor and to obtain and store acceleration data measured by the angle sensor. This acceleration data is triaxial acceleration data.

The controller of the turntable mechanical platform controls the turntable mechanical platform to sequentially rotate through at least one preset test angle about the first axis from its horizontal origin position. For example, the test angle is an angle between the turntable mechanical platform and the plane formed by the first and second axes, such as 10°, 20° . . . , 360°. That is, a test angle is added every 10° for a calibration point, resulting in N calibration points for full-range calibration about the first axis. Those skilled in the art will appreciate that the test angle can be converted to a three-dimensional angle.

At each test angle, the angle sensor outputs the first acceleration data. According to the correspondence between angle and acceleration, the angle sensor can calculate the second calibrated acceleration data corresponding to the test angle.

The relationship formula between angle and acceleration velocity is:

$${A}_{r} ( {ϕ}_{i} ) = {[ \begin{matrix}{a}_{x} \\ {a}_{y} \\ {a}_{z}\end{matrix} ]}_{r} = [ \begin{matrix}- sin ( {ϕ}_{i} * π / 180 ) * 9.81 \\ cos ( {ϕ}_{i} * π / 180 ) * 9.81 \\ 0\end{matrix} ] ,$$

wherein ϕᵢ is the test angle corresponding to the i-th calibration point, Aᵣ (ϕᵢ) is a vector matrix composed of calibrated acceleration data (aₓ, a_{y}, a_{z}) corresponding to the test angle, and 9.81 represents the value of gravity acceleration.

In some embodiments, a first offset is obtained based on the acceleration data measured by the angle sensor in a case where the turntable mechanical platform is in the first initial state; and the acceleration data measured by the angle sensor at each first test angle is calibrated based on the first offset to obtain the first acceleration data.

For example, in the first initial state of the turntable mechanical platform, the calibrated acceleration data of the angle sensor should be (0, 0, 0) in m/s², but the actual measured acceleration data is (0, 0.1, 0), resulting in the first offset (0, 0.1, 0). In subsequent tests, the angular velocity sensor will use the first offset to calibrate the actual measured acceleration data and output the calibrated acceleration data. This can avoid the process of controlling the turntable mechanical platform to find the zero point of the angle sensor during each subsequent measurement process, so that resource consumption can be reduced, and calibration efficiency can be improved.

In step 120, third acceleration data output by the angle sensor at each second test angle and corresponding fourth acceleration data which is nominal data are obtained in a case where the angle sensor rotates about the second axis in a situation that the turntable mechanical platform rotates 90° about the third axis, wherein the turntable mechanical platform in a second initial state of rotating about the second axis is parallel to the horizontal plane.

For example, after the full-range calibration of the angle sensor rotating about the first axis is completed, the controller controls the turntable mechanical platform to rotate 90° in the vertical direction, thereby achieving calibration of the angle sensor rotating about the second axis. This calibration process is similar to the calibration process of the angle sensor rotating about the first axis, and will not be repeated here.

In some embodiments, a second offset is obtained based on the acceleration data measured by the angle sensor in a case where the turntable mechanical platform is in the second initial state; and acceleration data measured by the angle sensor at each second test angle is calibrated based on the second offset to obtain the third acceleration data.

For example, in the second initial state of the turntable mechanical platform, the calibrated acceleration data of the angle sensor should be (0, 0, 0) in m/s², but the actual measured acceleration data is (0.1, 0, 0), resulting in a second offset (0.1, 0, 0). In subsequent tests, the angular velocity sensor will use this second offset to calibrate the actual measured acceleration data and output the calibrated acceleration data. This can avoid the process of controlling the turntable mechanical platform to find the zero point of the angle sensor during each subsequent measurement process, so that resource consumption can be reduced, and calibration efficiency can be improved.

In step 130, a calibration data model between the output acceleration data and the calibrated acceleration data is constructed, based on the first acceleration data, the second acceleration data, the third acceleration data, and the fourth acceleration data.

In some embodiments, a fitting process is performed on the first acceleration data, the second acceleration data, the third acceleration data and the fourth acceleration data to obtain a fitting function; the calibration data model is obtained based on coefficient parameters of the fitting function. For example, linear fitting is performed based on the least square method.

For example, the acceleration corresponding to the test angle ϕᵢ output by the angle sensor constitutes a vector matrix:

$${A}_{m} = {[ \begin{matrix}{a}_{x} \\ {a}_{y} \\ {a}_{z}\end{matrix} ]}_{m} .$$

The acceleration corresponding to the angle sensor's calibrated test angle ϕᵢ constitutes a vector matrix:

$${A}_{r} = {[ \begin{matrix}{a}_{x} \\ {a}_{y} \\ {a}_{z}\end{matrix} ]}_{r} .$$

Through linear fitting using the least square method, a fitting function between the two vectors is obtained: Aᵣ(ϕᵢ)=K·Aₘ(ϕᵢ)+C, wherein K and C are coefficient parameters of the fitting function, K is a 3*3 matrix and C is a 3*1 matrix.

In step 140, calibrated acceleration data corresponding to acceleration data output at any angle is determined based on the calibration data model.

In this step, since the coefficient parameters of the fitting function have been determined, for any angle, calibrated acceleration data can be obtained by substituting acceleration data output at that angle into the fitting function.

In step 150, a calibrated angle of the angle sensor at any angle is obtained based on the calibrated acceleration data of that angle.

For example, based on a relationship formula between angle and acceleration velocity, a calibrated angle corresponding to the calibrated acceleration data can be obtained.

In the above embodiment, a fitting process is performed by the angle sensor based on multi-axis acceleration signals to obtain a calibration data model between the output acceleration data and the calibrated acceleration data. Using this calibration data model, a calibrated angle of the angle sensor can be obtained corresponding to any angle, so that the calibration accuracy of the angle sensor can be improved.

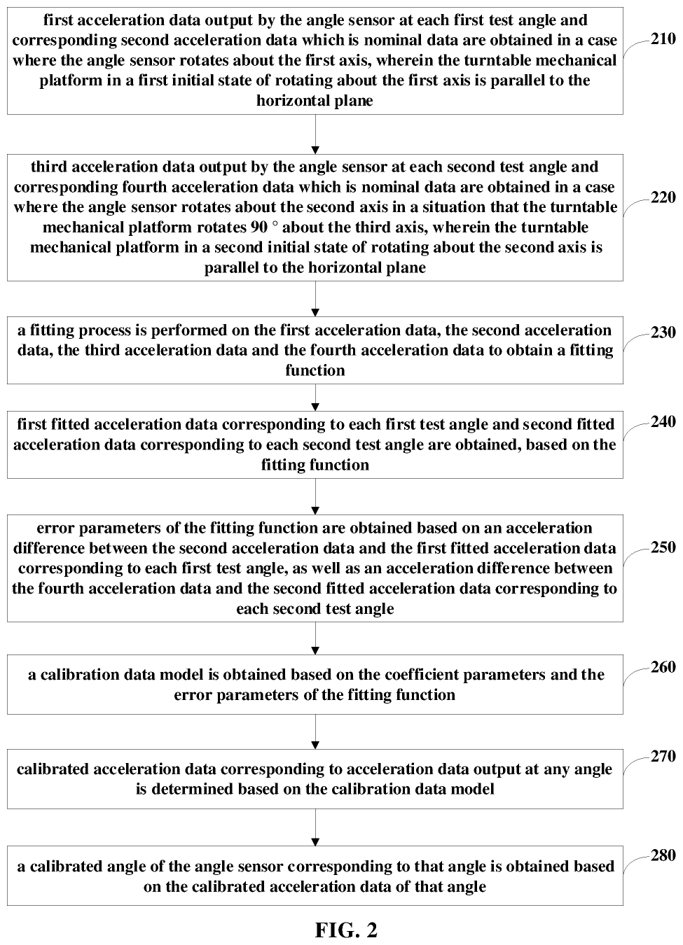

FIG. 2 is a flowchart of an automatic calibration method for an angle sensor according to other embodiments of the present disclosure.

In step 210, first acceleration data output by the angle sensor at each first test angle and corresponding second acceleration data which is nominal data are obtained in a case where the angle sensor rotates about the first axis, wherein the turntable mechanical platform in a first initial state of rotating about the first axis is parallel to the horizontal plane.

In step 220, third acceleration data output by the angle sensor at each second test angle and corresponding fourth acceleration data which is nominal data are obtained in a case where the angle sensor rotates about the second axis in a situation that the turntable mechanical platform rotates 90° about the third axis, wherein the turntable mechanical platform in a second initial state of rotating about the second axis is parallel to the horizontal plane.

In step 230, a fitting process is performed on the first acceleration data, the second acceleration data, the third acceleration data and the fourth acceleration data to obtain a fitting function.

In step 240, first fitted acceleration data corresponding to each first test angle and second fitted acceleration data corresponding to each second test angle are obtained, based on the fitting function.

For example, a matrix constituting of fitted acceleration data is

$${A}_{l} ( {ϕ}_{i} ) = {[ \begin{matrix}{a}_{x} \\ {a}_{y} \\ {a}_{z}\end{matrix} ]}_{l} = K \cdot {A}_{m} ( {ϕ}_{i} ) + C$$

In step 250, an error parameter of the fitting function are obtained based on an acceleration difference between the second acceleration data and the first fitted acceleration data corresponding to each first test angle, as well as an acceleration difference between the fourth acceleration data and the second fitted acceleration data corresponding to each second test angle.

For example, a linearized error matrix consisting of the error parameter is E(Aₘ(ϕᵢ))ₘ=Aᵣ(ϕᵢ)−Aₗ(ϕᵢ), wherein E(Aₘ(ϕᵢ))ₘ is a 3*N matrix.

In some embodiments, an average value of acceleration differences corresponding to the various first test angles and acceleration differences corresponding to the various second test angles is calculated to obtain an error parameter of the fitting function.

For example, if 36 first test angles and 36 second test angles are calibrated, 72 acceleration differences can be obtained. These 72 acceleration differences are averaged to obtain an error parameter that corresponds to a 3*1 matrix. The angle sensor stores this error parameter, so that in a case where outputting any calibrated angle in the future, there is no need to select the error parameter, which can improve the computational efficiency.

In step 260, a calibration data model is obtained based on the coefficient parameters and the error parameter of the fitting function.

For example, a calibrated acceleration vector matrix is

$${A}_{c} ( {ϕ}_{i} ) = K \cdot {A}_{m} ( {ϕ}_{i} ) + C + {E ( {A}_{m} ( {ϕ}_{i} ) )}_{m}$$

In some embodiments, the coefficient parameters and the error parameter of the fitting function are stored in a calibration parameter storage area in a memory space corresponding to the embedded software of the angle sensor for subsequent use.

In step 270, calibrated acceleration data corresponding to acceleration data output at any angle is determined based on the calibration data model.

In some embodiments, the error parameter value determined for the calibrated angular velocity data corresponding to the acceleration data that is output at any angle based on the calibration data model is: an acceleration difference corresponding to a test angle that is closest to that angle.

For example, in a case where constructing a calibration data model with 72 test angles, a 3*72 error parameter matrix is generated. If the test angles are 0°, 10°, 20°, . . . , 360°, for an angle of 9°, the acceleration difference corresponding to 10° is used as the error parameter to calculate the calibrated angular velocity corresponding to 9°.

In some embodiments, the error parameter value determined for the calibrated angular velocity data corresponding to the acceleration data that is output at any angle based on the calibration data model is: an acceleration difference corresponding to a test angle that is less than and closest to that angle.

For example, in a case where constructing a calibration data model with 72 test angles, a 3*72 error parameter matrix is generated. If the test angles are 0°, 10°, 20°, . . . , 360°, for an angle falling between 10° and 20°, the acceleration difference value corresponding to 10° is used as the error parameter for calculating the calibrated angular velocity corresponding to that angle, for an angle falling a range between 20° to 30°, the acceleration difference corresponding to 20° is used as the error parameter for calculating the calibrated angular velocity corresponding to that angle.

In step 280, a calibrated angle of the angle sensor corresponding to that angle is obtained based on the calibrated acceleration data of that angle.

In the above embodiment, after obtaining full-range calibration measurements of the angle sensor in multiple directions, a calibration data model containing a linearized error matrix is constructed by least square linear fitting, resulting in higher accuracy in subsequent angle calibration of the angle sensor. In addition, the calibration calculation process in this embodiment is executed by embedded software inside the angle sensor, greatly reducing the data transmission between the turntable platform and the angle sensor.

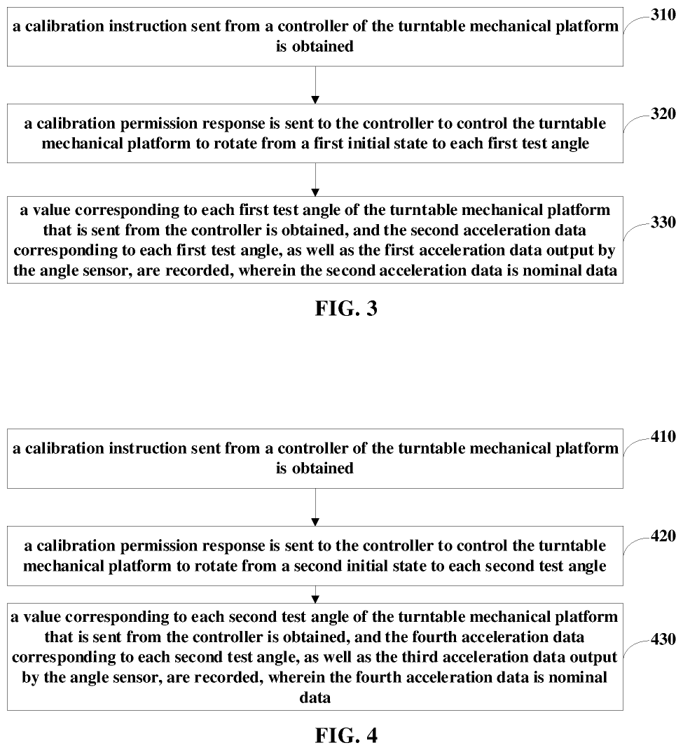

FIG. 3 is a flowchart of an automatic calibration method for an angle sensor according to further embodiments of the present disclosure, which is performed by embedded software inside the angle sensor.

In step 310, a calibration instruction sent from a controller of the turntable mechanical platform is obtained.

In some embodiments, embedded software inside the angle sensor obtains the calibration instruction sent from a controller of the turntable mechanical platform via a control local area network (CAN) bus. The CAN bus-based broadcast communication allows multiple angle sensors to be calibrated simultaneously without interference, enabling automatic and dynamic angle calibration for multiple axes.

In step 320, a calibration permission response is sent to the controller to control the turntable mechanical platform to rotate from a first initial state to each first test angle.

After obtaining the calibration permission response as feedback from the angle sensor, the controller controls the turntable mechanical platform to return to the origin position for calibrating the angle sensor. Otherwise, no control is made to the turntable mechanical platform.

In step 330, a value corresponding to each first test angle of the turntable mechanical platform that is sent from the controller is obtained, and the second acceleration data corresponding to each first test angle, as well as the first acceleration data output by the angle sensor, are recorded, wherein the second acceleration data is nominal data.

For example, the embedded software of the angle sensor records angle signal values sent from the controller through the CAN bus, updates calibrated angle data, and records the three-axis acceleration measurement data of the internal IMU module.

In this embodiment, the controller of the turntable mechanical platform executes the calibration instruction, controls the turntable mechanical platform to rotate about the first axis to a corresponding angle to enable the angle sensor to detect acceleration data corresponding to the current calibration position, thereby facilitating subsequent training of a calibration data model.

FIG. 4 is a flowchart of an automatic calibration method for an angle sensor according to further embodiments of the present disclosure, which is performed by embedded software inside the angle sensor.

In step 410, a calibration instruction sent from a controller of the turntable mechanical platform is obtained.

In some embodiments, embedded software inside the angle sensor obtains the calibration instruction sent from a controller of the turntable mechanical platform via a CAN bus. The CAN bus-based broadcast communication allows multiple angle sensors to be calibrated simultaneously without interference, enabling automatic and dynamic angle calibration for multiple axes.

In step 420, a calibration permission response is sent to the controller to control the turntable mechanical platform to rotate from a second initial state to each second test angle.

After receiving the calibration permission response as feedback from the angle sensor, the controller controls the turntable mechanical platform to return to the origin position for calibrating the angle sensor. Otherwise, no control is made to the turntable mechanical platform.

In step 430, a value corresponding to each second test angle of the turntable mechanical platform that is sent from the controller is obtained, and the fourth acceleration data corresponding to each second test angle, as well as the third acceleration data output by the angle sensor, are recorded, wherein the fourth acceleration data is nominal data.

For example, the embedded software of the angle sensor records angle signal values sent from the controller through the CAN bus, updates calibrated angle data, and records the three-axis acceleration measurement data of the internal IMU module.

In this embodiment, the controller of the turntable mechanical platform executes the calibration instruction, controls the turntable mechanical platform to rotate about the second axis to a corresponding angle to enable the angle sensor to detect acceleration data corresponding to the current calibration position, thereby facilitating subsequent training of a calibration data model.

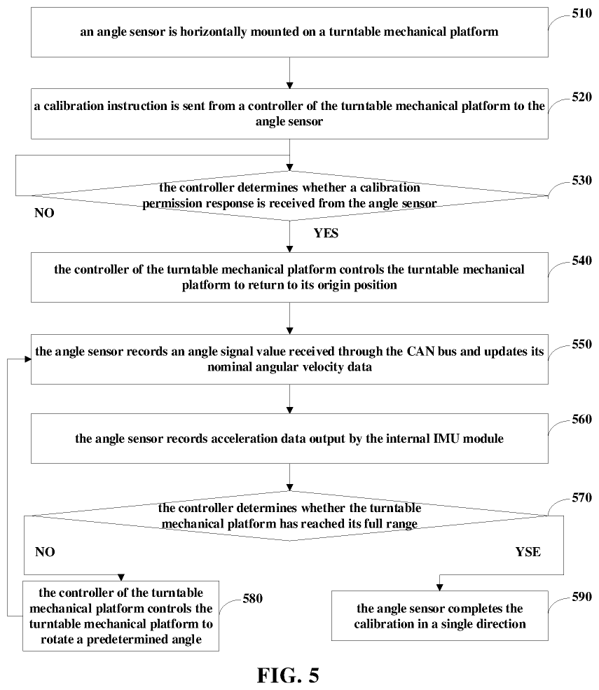

FIG. 5 is a flowchart of an automatic calibration method for an angle sensor according to further embodiments of the present disclosure.

In step 510, an angle sensor is horizontally mounted on a turntable mechanical platform.

In step 520, a calibration instruction is sent from a controller of the turntable mechanical platform to the angle sensor.

In step 530, the controller of the turntable mechanical platform determines whether a calibration permission response is received from the angle sensor. If so, the method proceeds to step 540. Otherwise, the method continues to wait.

In step 540, the controller of the turntable mechanical platform controls the turntable mechanical platform to return to its origin position.

In step 550, the angle sensor records an angle signal value received through the CAN bus and updates its nominal angular velocity data.

In step 560, the angle sensor records acceleration data output by the internal IMU module.

In step 570, the controller of the turntable mechanical platform determines whether the turntable mechanical platform has reached its full range. If so, the method proceeds to step 580; otherwise, the method proceeds to step 590.

In step 580, the controller of the turntable mechanical platform controls the turntable mechanical platform to rotate a predetermined angle, and the method continues with step 550.

In some embodiments, the controller of the turntable mechanical platform controls the platform to rotate a fixed time or angle to meet a subsequent nominal value, for example, an angle of (1/N)*full scale for each rotation.

In step 590, the angle sensor completes the calibration in a single direction.

In some embodiments, the calibrated angle corresponding to any angle is verified, based on a test angle rotated by the turntable mechanical platform. That is, whether the calibration data model of this disclosure is accurate is determined to facilitate the batch calibration of subsequent products. As shown in Table 1, for an angle sensor with a dynamic accuracy of 0.15°, the calibration method disclosed in this disclosure can improve the accuracy of calibration.

TABLE 1

| Normal Angle | Before Calibration | After Calibration |
|---|---|---|
| −30 | −29.42 | −29.92 |
| −25 | −24.72 | −24.92 |
| −20 | −19.92 | −19.97 |
| −15 | −14.76 | −14.96 |
| −10 | −9.66 | −9.86 |
| −5 | −4.39 | −4.93 |
| 0 | −0.19 | 0.04 |
| 5 | 4.76 | 5.12 |
| 10 | 9.86 | 10.14 |
| 15 | 14.71 | 15.1 |
| 20 | 19.22 | 20.11 |
| 25 | 24.76 | 25.14 |
| 30 | 29.69 | 30.09 |

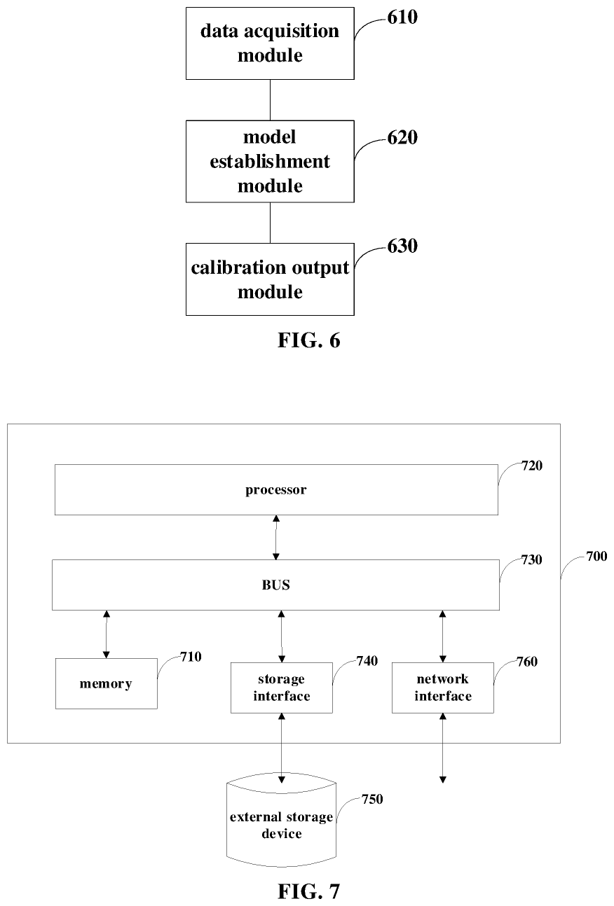

FIG. 6 is a schematic structure diagram of an automatic calibration device for an angle sensor according to some embodiments of the present disclosure, wherein the automatic calibration device for an angle sensor is in the form of embedded software in an angle sensor, the angle sensor being placed on a turntable mechanical platform that can rotate about a first axis, a second axis, and a third axis, the first axis and second axis being perpendicular to each other and forming a horizontal plane, and the third axis being perpendicular to the horizontal plane.

The automatic calibration device for an angle sensor comprises a data acquisition module 610, a model establishment module 620, and a calibration output module 630.

The data acquisition module 610 is configured to obtain first acceleration data output by the angle sensor at each first test angle and corresponding second acceleration data in a case where the angle sensor rotates about the first axis, wherein the turntable mechanical platform in a first initial state of rotating about the first axis is parallel to the horizontal plane; obtain third acceleration data output by the angle sensor at each second test angle and fourth acceleration data in a case where the angle sensor rotates about the second axis in a situation that the turntable mechanical platform rotates 90 degrees about the third axis, wherein the turntable mechanical platform in a second initial state of rotating about the second axis is parallel to the horizontal plane.

In some embodiments, the data acquisition module 610 comprises a data interface, a calculator, and an IMU module, wherein the data interface receives the value of each test angle output by the controller of the turntable mechanical platform through a CAN bus; the calculator calculates calibrated acceleration data corresponding to each test angle based on a formula relationship between angle and acceleration velocity; the IMU outputs measured acceleration data.

In some embodiments, the data acquisition module 610 obtains a calibration instruction sent from a controller of the turntable mechanical platform; sends a calibration permission response to the controller to control the turntable mechanical platform to rotate from the first initial state to each first test angle; obtains a value corresponding to each first test angle of the turntable mechanical platform that is sent from the controller, and recording second acceleration data corresponding to each first test angle, and first acceleration data output by the angle sensor.

In some embodiments, the data acquisition module 610 obtains a calibration instruction sent from a controller of the turntable mechanical platform; sends a calibration permission response to the controller to control the turntable mechanical platform to rotate from the second initial state to each second test angle; obtains a value corresponding to each second test angle of the turntable mechanical platform that is sent from the controller, and recording fourth acceleration data corresponding to each second test angle, and third acceleration data output by the angle sensor.

In some embodiments, the data acquisition module 610 receives a calibration instruction sent from a controller of the turntable mechanical platform through a CAN bus.

The model establishment module 620 is implemented by, for example, a processor, and is configured to construct a calibration data model between the output acceleration data and the calibrated acceleration data, based on the first acceleration data, the second acceleration data, the third acceleration data, and the fourth acceleration data.

In some embodiments, the model establishment module 620 performs a fitting process on the first acceleration data, the second acceleration data, the third acceleration data and the fourth acceleration data to obtain a fitting function; and obtains the calibration data model based on coefficient parameters of the fitting function. For example, linear fitting is performed based on the least square method.

In some embodiments, the model establishment module 620 obtains first fitted acceleration data corresponding to each first test angle and second fitted acceleration data corresponding to each second test angle, based on the fitting function; obtains the error parameter of the fitting function based on an acceleration difference between the second acceleration data and the first fitted acceleration data corresponding to each first test angle, as well as an acceleration difference between the fourth acceleration data and the second fitted acceleration data corresponding to each second test angle; obtains the calibration data model based on the coefficient parameters and the error parameter of the fitting function.

In some embodiments, obtaining the error parameter of the fitting function comprises: calculating an average value of the acceleration differences corresponding to the various first test angles and the acceleration differences corresponding to the various second test angles to obtain the error parameter of the fitting function.

In some embodiments, the automatic calibration device for an angle sensor further comprises a memory, which is used to store the coefficient parameters and the error parameter of the calibration data model described above to facilitate subsequent use of the calibration data model.

The calibration output module 630 is implemented by, for example, a processor and configured to determine the calibrated acceleration data corresponding to the acceleration data output at any angle based on the calibration data model; and obtain the calibrated angle of the angle sensor corresponding to any angle based on the calibrated acceleration data at that angle.

In some embodiments, the error parameter value determined for the calibrated angular velocity data corresponding to the acceleration data that is output at any angle based on the calibration data model is: an acceleration difference corresponding to a test angle that is closest to that angle.

In some embodiments, the error parameter value determined for the calibrated angular velocity data corresponding to the acceleration data that is output at any angle based on the calibration data model is: an acceleration difference corresponding to a test angle that is less than and closest to that angle.

In the above embodiment, a fitting process is performed by the angle sensor based on multi-axis acceleration signals to obtain a calibration data model between the output acceleration data and the calibrated acceleration data. Using this calibration data model, a calibrated angle of the angle sensor can be obtained corresponding to any angle, so that the calibration accuracy of the angle sensor can be improved.

FIG. 7 is a schematic structure diagram of an automatic calibration device for an angle sensor according to other embodiments of the present disclosure. The automatic calibration device for angle sensor 700 comprises a memory 710 and a processor 720. Wherein: the memory 710 may be a magnetic disk, flash memory or any other non-volatile storage medium. The memory is used to store instructions of a corresponding embodiment described above. The processor 720 is coupled to memory 710 and may be implemented as one or more integrated circuits, such as a microprocessor or microcontroller. The processor 720 is used to execute the instructions stored in the memory.

In some embodiments, the processor 720 is coupled to the memory 710 via a bus 730. The automatic angle sensor calibration device 700 may be further connected to an external storage device 750 through a storage interface 740 to access external data, and may be further connected to a network or another computer system (not shown) through a network interface 760, the details of which will not described herein.

In this embodiment, through storing data instructions in a memory and processing the above instructions using a processor, the calibration accuracy of the angle sensor can be improved.

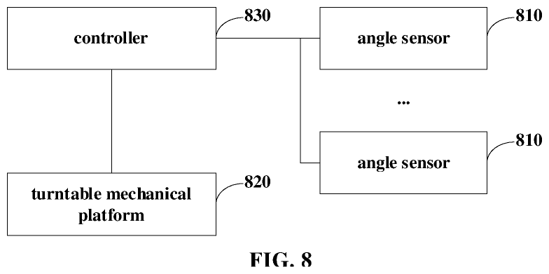

FIG. 8 is a schematic structure diagram of an automatic calibration system for an angle sensor according to some embodiments of the present disclosure. The automatic calibration system for angle sensor comprises at least one angle sensor 810, a turntable mechanical platform 820, and a controller 830 of the turntable mechanical platform.

Each of the at least one angle sensor 810 is provided with an automatic calibration device for an angle sensor, which is implemented based on internal calibration software of the corresponding angle sensor. The turntable mechanical platform 820 is used for mounting the at least one angle sensor. The controller 830 is configured for controlling the turntable mechanical platform to rotate about the first axis, the second axis, and the third axis, and sending rotation angles of the turntable mechanical platform about the first axis and the second axis to the automatic calibration device for an angle sensor.

The angle sensor is, for example, a dynamic angle sensor. The controller of the turntable mechanical platform communicates with the turntable mechanical platform via a serial port, such as a UART (Universal Asynchronous Receiver/Transmitter) serial port. The controller of the turntable mechanical platform communicates with the automatic angle sensor calibration device inside the angle sensor via a CAN bus.

In some embodiments, the controller is further configured for sending a calibration instruction to the automatic angle sensor calibration device and, upon receiving a calibration response, controlling the turntable mechanical platform to rotate about the first axis or the second axis.

In this embodiment, there is no need to add additional upper computer operating software. The controller of the turntable mechanical platform communicates directly with the angle sensor, and the angle calibration calculation is carried out by the embedded software of the angle sensor, so that data transmission between the turntable mechanical platform and the sensor can be greatly reduced. In addition, the CAN bus-based broadcast communication allows multiple angle sensors to be calibrated simultaneously without interference, enabling automatic and dynamic angle calibration for multiple axes.

In other embodiments, there is provided a computer-readable storage medium stored thereon computer program instructions that, when executed by a processor, implement the steps of the method of the above embodiment. One skilled in the art should understand that, the embodiments of the present disclosure may be provided as a method, an device, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical storage device, etc.) having computer-usable program code embodied therein.

The present disclosure is described with reference to flowcharts and/or block diagrams of methods, devices (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing device to generate a machine such that the instructions executed by a processor of a computer or other programmable data processing device to generate means implementing the functions specified in one or more flows of the flowcharts and/or one or more blocks of the block diagrams.

The computer program instructions may also be stored in a computer readable storage device capable of directing a computer or other programmable data processing device to operate in a specific manner such that the instructions stored in the computer readable storage device produce an article of manufacture including instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

Heretofore, the present disclosure has been described in detail. In order to avoid obscuring the concepts of the present disclosure, some details known in the art are not described. Based on the above description, those skilled in the art can understand how to implement the technical solutions disclosed herein.

The method and device of the present disclosure may be implemented in many ways. For example, the method and device of the present disclosure may be implemented by software, hardware, firmware, or any combination of software, hardware, and firmware. The above sequence of steps of the method is merely for the purpose of illustration, and the steps of the method of the present disclosure are not limited to the above-described specific order unless otherwise specified. In addition, in some embodiments, the present disclosure may also be implemented as programs recorded in a recording medium, which include machine-readable instructions for implementing the method according to the present disclosure. Thus, the present disclosure also covers a recording medium storing programs for executing the method according to the present disclosure.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

What is claimed is:

1. An automatic calibration method for an angle sensor, wherein the angle sensor is placed on a turntable mechanical platform, the turntable mechanical platform being rotatable about a first axis, a second axis, and a third axis, the first axis and the second axis being perpendicular to each other and forming a horizontal plane, the third axis being perpendicular to the horizontal plane, and the automatic calibration method for the angle sensor comprising:
obtaining first acceleration data output by the angle sensor at each first test angle and corresponding second acceleration data which is nominal data in a case where the angle sensor rotates about the first axis, wherein the turntable mechanical platform in a first initial state of rotating about the first axis is parallel to the horizontal plane;
obtaining third acceleration data output by the angle sensor at each second test angle and corresponding fourth acceleration data which is nominal data in a case where the angle sensor rotates about the second axis in a situation that the turntable mechanical platform rotates 90 degrees about the third axis, wherein the turntable mechanical platform in a second initial state of rotating about the second axis is parallel to the horizontal plane;
constructing a calibration data model between output acceleration data and calibrated acceleration data, based on the first acceleration data, the second acceleration data, the third acceleration data, and the fourth acceleration data;
determining calibrated acceleration data corresponding to acceleration data output at any angle based on the calibration data model; and
obtaining a calibrated angle of the angle sensor at any angle based on the calibrated acceleration data of that angle.

2. The automatic calibration method for an angle sensor according to claim 1, wherein constructing the calibration data model between the output acceleration data and the calibrated acceleration data comprises:
obtaining a fitting function by performing a fitting process on the first acceleration data, the second acceleration data, the third acceleration data and the fourth acceleration data; and
obtaining the calibration data model based on coefficient parameters of the fitting function.

3. The automatic calibration method for an angle sensor according to claim 2, wherein constructing the calibration data model between the output acceleration data and the calibrated acceleration data further comprises:
obtaining first fitted acceleration data corresponding to each first test angle and second fitted acceleration data corresponding to each second test angle, based on the fitting function;
obtaining an error parameter of the fitting function based on an acceleration difference between the second acceleration data and the first fitted acceleration data corresponding to each first test angle, as well as an acceleration difference between the fourth acceleration data and the second fitted acceleration data corresponding to each second test angle; and
obtaining the calibration data model based on the coefficient parameters and the error parameter of the fitting function.

4. The automatic calibration method for an angle sensor according to claim 3, wherein the error parameter value determined for the calibrated angular velocity data corresponding to the acceleration data that is output at any angle based on the calibration data model is an acceleration difference corresponding to a test angle that is closest to that angle.

5. The automatic calibration method for an angle sensor according to claim 3, wherein the error parameter value determined for the calibrated angular velocity data corresponding to the acceleration data that is output at any angle based on the calibration data model is an acceleration difference corresponding to a test angle that is less than and closest to that angle.

6. The automatic calibration method for an angle sensor according to claim 3, wherein obtaining the error parameter of the fitting function comprises:
calculating an average value of the acceleration difference corresponding to each first test angle and the acceleration difference corresponding to each second test angle to obtain the error parameter of the fitting function.

7. The automatic calibration method for an angle sensor according to claim 2, wherein performing a fitting process comprises:
performing linear fitting based on a least square method.

8. The automatic calibration method for an angle sensor according to claim 1, wherein obtaining first acceleration data output by the angle sensor at each first test angle and corresponding second acceleration data which is nominal data in a case where the angle sensor rotates about the first axis comprises:
receiving a calibration instruction sent from a controller of the turntable mechanical platform;
sending a calibration permission response to the controller to control the turntable mechanical platform to rotate from the first initial state to each first test angle; and
receiving a value corresponding to each first test angle of the turntable mechanical platform that is sent from the controller, and recording the second acceleration data corresponding to each first test angle, and the first acceleration data output from the angle sensor.

9. The automatic calibration method for an angle sensor according to claim 1, wherein obtaining third acceleration data output by the angle sensor at each second test angle and corresponding fourth acceleration data which is nominal data in a case where the angle sensor rotates about the first axis comprises:
receiving a calibration instruction sent from a controller of the turntable mechanical platform;
sending a calibration permission response to the controller to control the turntable mechanical platform to rotate from the second initial state to each second test angle; and
receiving a value corresponding to each second test angle of the turntable mechanical platform that is sent from the controller, and recording the fourth acceleration data corresponding to each second test angle, and the third acceleration data output by the angle sensor.

10. The automatic calibration method for an angle sensor according to claim 8, wherein receiving a calibration instruction sent from a controller of the turntable mechanical platform comprises:
receiving the calibration instruction sent from the controller of the turntable mechanical platform via a control local area network (CAN) bus.

11. The automatic calibration method for an angle sensor according to claim 1, wherein obtaining first acceleration data output by the angle sensor at each first test angle comprises:
obtaining a first offset based on acceleration data measured by the angle sensor in a case where the turntable mechanical platform is in the first initial state; and
calibrating acceleration data measured by the angle sensor at each first test angle based on the first offset to obtain the first acceleration data.

12. The automatic calibration method for an angle sensor according to claim 1, wherein obtaining third acceleration data output by the angle sensor at each second test angle comprises:
obtaining a second offset based on acceleration data measured by the angle sensor in a case where the turntable mechanical platform is in the second initial state; and
calibrating acceleration data measured by the angle sensor at each second test angle based on the second offset to obtain the third acceleration data.

13. The automatic calibration method for an angle sensor according to claim 1, further comprising:
verifying the calibrated angle corresponding to any angle, based on a test angle rotated by the turntable mechanical platform.

14. An automatic calibration device for an angle sensor, comprising:
a memory; and
a processor coupled to the memory, the processor configured to, based on instructions stored in the memory, carry out the automatic calibration method for the angle sensor, wherein the angle sensor is placed on a turntable mechanical platform, the turntable mechanical platform being rotatable about a first axis, a second axis, and a third axis, the first axis and the second axis being perpendicular to each other and forming a horizontal plane, the third axis being perpendicular to the horizontal plane, and the automatic calibration method for the angle sensor comprising:
obtaining first acceleration data output by the angle sensor at each first test angle and corresponding second acceleration data which is nominal data in a case where the angle sensor rotates about the first axis, wherein the turntable mechanical platform in a first initial state of rotating about the first axis is parallel to the horizontal plane;
obtaining third acceleration data output by the angle sensor at each second test angle and corresponding fourth acceleration data which is nominal data in a case where the angle sensor rotates about the second axis in a situation that the turntable mechanical platform rotates 90 degrees about the third axis, wherein the turntable mechanical platform in a second initial state of rotating about the second axis is parallel to the horizontal plane;
constructing a calibration data model between output acceleration data and calibrated acceleration data, based on the first acceleration data, the second acceleration data, the third acceleration data, and the fourth acceleration data;
determining calibrated acceleration data corresponding to acceleration data output at any angle based on the calibration data model; and
obtaining a calibrated angle of the angle sensor at any angle based on the calibrated acceleration data of that angle.

15. The automatic calibration device for an angle sensor according to claim 14, wherein constructing the calibration data model between the output acceleration data and the calibrated acceleration data comprises:
obtaining a fitting function by performing a fitting process on the first acceleration data, the second acceleration data, the third acceleration data and the fourth acceleration data; and
obtaining the calibration data model based on coefficient parameters of the fitting function.

16. An automatic calibration system for an angle sensor, comprising:
at least one angle sensor, of which each angle sensor is provided with an automatic calibration device for the angle sensor according to claim 14;
a turntable mechanical platform for mounting the at least one angle sensor; and
a controller of the turntable mechanical platform configured to control the turntable mechanical platform to rotate about the first axis, the second axis, and the third axis, and send rotation angles of the turntable mechanical platform about the first axis and the second axis to the automatic calibration device for the angle sensor.

17. The automatic calibration system for an angle sensor according to claim 16, wherein the controller is further configured to send a calibration instruction to the automatic calibration device for the angle sensor and, upon receiving a calibration response, control the turntable mechanical platform to rotate about the first axis or the second axis.

18. The automatic calibration system for an angle sensor according to claim 16, wherein the automatic calibration device for the angle sensor is implemented based on calibration software inside a corresponding angle sensor.

19. The automatic calibration system for an angle sensor according to claim 16, wherein the controller communicates with the turntable mechanical platform via a serial port.

20. A non-transitory computer-readable storage medium stored thereon computer program instructions that, when executed by a processor, implement the automatic calibration method for an angle sensor, wherein the angle sensor is placed on a turntable mechanical platform, the turntable mechanical platform being rotatable about a first axis, a second axis, and a third axis, the first axis and the second axis being perpendicular to each other and forming a horizontal plane, the third axis being perpendicular to the horizontal plane, and the automatic calibration method for the angle sensor comprising:
obtaining first acceleration data output by the angle sensor at each first test angle and corresponding second acceleration data which is nominal data in a case where the angle sensor rotates about the first axis, wherein the turntable mechanical platform in a first initial state of rotating about the first axis is parallel to the horizontal plane;
obtaining third acceleration data output by the angle sensor at each second test angle and corresponding fourth acceleration data which is nominal data in a case where the angle sensor rotates about the second axis in a situation that the turntable mechanical platform rotates 90 degrees about the third axis, wherein the turntable mechanical platform in a second initial state of rotating about the second axis is parallel to the horizontal plane;
constructing a calibration data model between output acceleration data and calibrated acceleration data, based on the first acceleration data, the second acceleration data, the third acceleration data, and the fourth acceleration data;
determining calibrated acceleration data corresponding to acceleration data output at any angle based on the calibration data model; and
obtaining a calibrated angle of the angle sensor at any angle based on the calibrated acceleration data of that angle.
